(19) United States
(12) Patent Application Publication
(10) Pub. No.: US 2016/0210769 A1
(43) Pub. Date: Jul. 21, 2016

(54) SYSTEM AND METHOD FOR A MULTI-DEVICE DISPLAY UNIT

(71) Applicant: Dell Products L.P., Round Rock, TX (US)

(72) Inventors: Shekar Babu Suryanarayana, Bangalore (IN); Ankit Singh, Bangalore (IN)

(21) Appl. No.: 14/599,276

(22) Filed: Jan. 16, 2015

(51) Int. Cl. G06T 11/60; G06T 3/40

(52) U.S. Cl. CPC G06T 11/60; G06T 3/40

(57) ABSTRACT

A system and method for a multi-device display is disclosed. The method includes detecting, at a multi-device display controller, a first connection with a first external device and a second connection with a second external device. The method further includes receiving video data from the first external device and the second external device, and scaling the video data from the first external device to correspond to a first region of a screen. The screen is associated with the multi-device display controller. The method also includes scaling the video data from the second external device to correspond to a second region of the screen, and outputting the scaled video data from the first external device to the first region of the screen and the scaled video data from the second external device to the second region of the screen.

### TECHNICAL FIELD

This disclosure relates generally to information handling systems and, more particularly, to a system and method for a multi-device display unit.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Display devices, such as liquid crystal displays (LCDs) are commonly integrated within portable information handling systems configured in the form of laptop, notebook, netbook, and tablet computers, among others, and personal mobile devices, such as smart phones. Desktop or non-portable information handling systems also use display devices, which are often implemented as separate devices with input ports for graphical display signals. As users of information handling systems increasingly own and operate multiple systems, including portable systems and personal mobile devices, it may be difficult for users to easily integrate display outputs from multiple sources into a single display device.

### SUMMARY

In some embodiments, a method for a multi-device display is disclosed. The method includes detecting, at a multi-device display controller, a first connection with a first external device and a second connection with a second external device. The method further includes receiving video data from the first external device and the second external device, and scaling the video data from the first external device to correspond to a first region of a screen. The screen is associated with the multi-device display controller. The method also includes scaling the video data from the second external device to correspond to a second region of the screen, and outputting the scaled video data from the first external device to the first region of the screen and the scaled video data from the second external device to the second region of the screen.

In another embodiments, a multi-device display unit is disclosed. The multi-device display unit includes a screen and a multi-device display controller communicatively coupled to the screen. The multi-device display controller has a processor with access to a memory, and the memory stores instructions that, when executed by the processor, cause the processor to detect a first connection with a first external device and a second connection with a second external device. The processor is further caused to receive video data from the first external device and the second external device, and scale the video data from the first external device to correspond to a first region of the screen. The processor is also caused to scale the video data from the second external device to correspond to a second region of the screen, and output the scaled video data from the first external device to the first region of the screen and the scaled video data from the second external device to the second region of the screen.

In a further embodiments, non-transitory computer-readable medium is disclosed that stores instructions, that, when executed by a processor of a multi-device display unit, cause the processor to detect a first connection with a first external device and a second connection with a second external device. The processor is further caused to receive video data from the first external device and the second external device, and scale the video data from the first external device to correspond to a first region of a screen. The screen is associated with the multi-device display unit. The processor is also caused to scale the video data from the second external device to correspond to a second region of the screen, and output the scaled video data from the first external device to the first region of the screen and the scaled video data from the second external device to the second region of the screen.

### BRIEF DESCRIPTION OF THE DRAWINGS

For a more complete understanding of the present disclosure and its features and advantages, reference is now made to the following description, taken in conjunction with the accompanying drawings, which may include drawings that are not to scale and wherein like reference numbers indicate like features, in which:

FIG. 1 illustrates a block diagram depicting selected elements of an information handling system in accordance with some embodiments of the present disclosure;

FIG. 2 illustrates a block diagram depicting selected elements of a multi-device display unit in accordance with some embodiments of the present disclosure;

FIG. 3 illustrates a block diagram depicting selected elements of a multi-device display system in accordance with some embodiments of the present disclosure;

FIG. 4 illustrates a functional diagram depicting selected elements of a multi-device display unit in accordance with some embodiments of the present disclosure;

FIG. 5 illustrates an exemplary screen 204 for generating display regions 510 in accordance with some embodiments of the present disclosure; and

FIG. 6 illustrates a flowchart of an example method for utilizing a multi-device display unit in accordance with some embodiments of the present disclosure.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72”.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a personal digital assistant (PDA), a consumer electronic device, a network storage device, or another suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk (CD), random access memory (RAM), read-only memory (ROM), CD-ROM, DVD, electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

As larger displays become more widespread with certain information handling systems, and as more users own and operate multiple devices, including portable information handling systems and personal mobile devices, the ability to integrate display outputs of different devices on a single display screen becomes increasingly desirable. Moreover, integrating the navigation, access, and control of multiple devices using the single display screen and associated I/O devices may allow users to interact with multiple devices in parallel. Accordingly, the present disclosure is directed to systems and methods for a multi-device, or “smart” display unit that allows viewing, navigation, access, and control of multiple devices through a multi-device display screen. Additionally, some embodiments allow multiple users to interact with a multi-device display screen simultaneously by each using the interaction tools on the separate devices and/or the I/O devices associated with the multi-device display unit. In some embodiments, the multi-device display unit concurrently displays at least two display regions where each display region corresponds to an output from a different information handling system or other device, such as a camera. For example, one display region may correspond to a stationary information handling system while a second display region may correspond to a portable information handling system, such as a personal mobile device. Further, in some embodiments, a power saver mode allows certain regions of the display screen of the multi-device display unit to be powered down to minimize energy consumption.

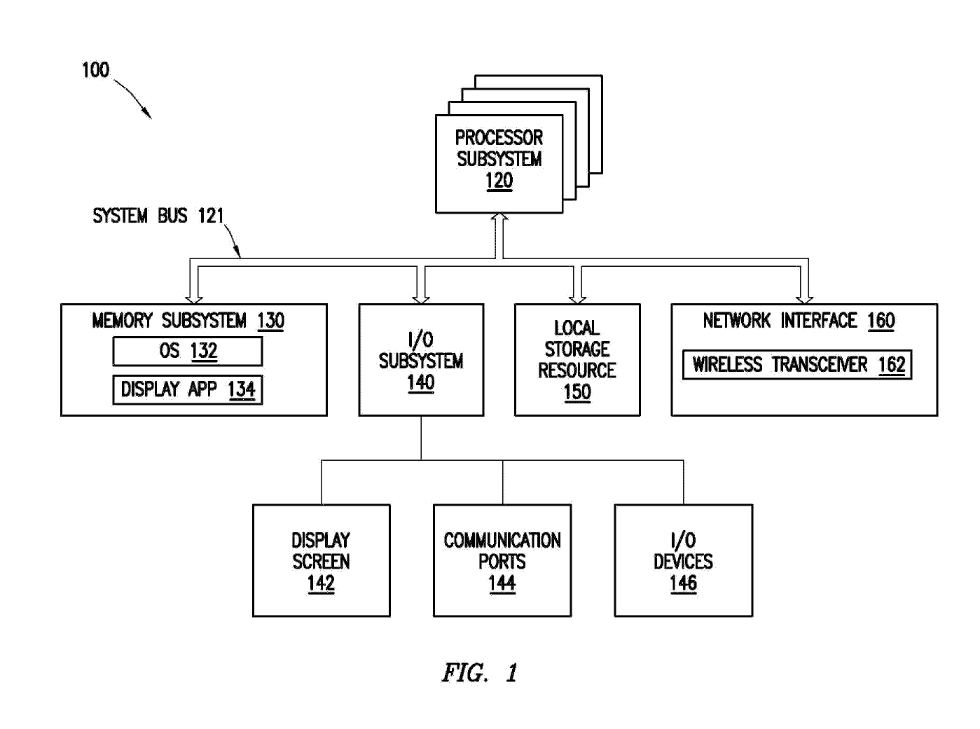

Embodiments of the present disclosure and its advantages are best understood by referring to FIGS. 1 through 6 of the drawings, like numerals being used for like and corresponding parts of the various drawings.

FIG. 1 illustrates a block diagram depicting selected elements of information handling system 100 in accordance with some embodiments of the present disclosure. As described herein, information handling system 100 may represent a personal computing device, such as a personal computer system, a desktop computer, a laptop computer, a notebook computer, or other suitable devices operated by a user. In some embodiments, information handling system 100 may represent a portable information handling system or a handheld computing device, such as a tablet computer. A portable information handling system may represent any of a variety of mobile devices with communication and data processing capability. In some embodiments, information handling system 100 represents a smart phone that may include various functionality selected from: cellular telephony, wireless networking, location sensing, motion sensing, digital imaging, touch screen operation, multimedia playback, and data storage among others. Accordingly, while certain aspects of information handling system 100 are shown in FIG. 1 for descriptive purposes, it will be understood that in different embodiments, information handling system 100 may include different types of functionality.

In some embodiments, components of information handling system 100 may include, but are not limited to, processor subsystem 120, which may comprise one or more processors, and system bus 121 that communicatively couples various system components to processor subsystem 120 including, for example, memory subsystem 130, I/O subsystem 140, local storage resource 150, and network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130). In the same or alternative embodiments, processor subsystem 120 may interpret and/or execute program instructions and/or process data stored remotely (e.g., in a network storage resource, not shown).

Memory subsystem 130 may comprise a system, device, or apparatus operable to retain and/or retrieve program instructions and/or data for a period of time (e.g., computer-readable media). Memory subsystem 130 may comprise RAM, EEPROM) a PCMCIA card, flash memory, magnetic storage, opto-magnetic storage, and/or a suitable selection and/or array of volatile or non-volatile memory that retains data after power to its associated information handling system, such as system 100, is powered down. Memory subsystem 130 may store data and/or instructions executable by processor subsystem 120. Memory subsystem 130 is shown including operating system (OS) 132, which may represent a mobile operating system being executed by processor subsystem 120. Examples of instances of OS 132 include versions of Android, Windows, Wyse ThinOS, Linux, Apple iOS, or other suitable OSs. Also, memory subsystem 130 may store display application 134 that is executable by processor subsystem 120 to enable sending display output to a multi-device display unit, as described herein. It is noted that various applications may execute on information handling system 100 to access diverse types of functionality included with information handling system 100, such as, but not limited to, imaging, communication, location-based services, gestures, touch input, motion of information handling system 100, Internet connectivity, a browser, a media player and recorder, voice over IP and video communication software, and software for remote access to cloud services or other remote content or services.

I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. As shown, I/O subsystem 140 may comprise display screen 142, communication ports 144, and/or I/O devices 146. Display screen 142 may be an integrated display device, for example an LCD display on a laptop computer. Display screen 142 may include a touch controller and/or touch panel that may include circuitry for enabling touch functionality in conjunction with display screen 142. Communication ports 144 may include display interfaces that support one or more of the mobile high-definition link (MHL) standard, the high-definition multimedia interface (HDMI) standard, or the display port (DP) standard. Communication ports 144 may also include one or more universal serial bus (USB) ports (e.g., standard, mini or micro USB), one or more removable memory slots (e.g., SD card slots), and audio capabilities through the MHL, HDMI, or DP interfaces. Information handling system 100 may include one or more I/O devices 146, where appropriate. I/O devices 146 may include a keyboard, keypad, microphone, monitor, mouse, printer, scanner, speaker, still camera, stylus, tablet, touch screen, trackball, video camera, another suitable I/O device or a combination of two or more of these. I/O device 146 may include one or more sensors. This disclosure contemplates any suitable I/O devices 146 and any suitable I/O interfaces for them. I/O interfaces may include hardware, software, or both, providing one or more interfaces for communication between information handling system 100 and one or more I/O devices 146. Where appropriate, I/O interfaces may include one or more device or software drivers enabling processor subsystem 120 to drive one or more I/O devices 146.

As noted previously, a user of information handling system 100 (e.g., a tablet computer, a laptop, a personal mobile device, a smart phone) may desire to display the output from display screen 142 and/or the output from one or more cameras, or other suitable external devices on a multi-device display screen. As will be described in further detail herein, information handling system 100 may support operation with a multi-device display unit that is enabled to simultaneously display and allow manipulation of graphical content from at least two different sources, e.g., information handling systems and/or cameras.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data.

Network interface 160 may be a suitable system, apparatus, or device operable to serve as an interface between information handling system 100 and a network (not shown). Network interface 160 may enable information handling system 100 to communicate over the network using a suitable transmission protocol and/or standard, including, but not limited to, transmission protocols and/or standards. In some embodiments, network interface 160 may be communicatively coupled via the network to a network storage resource (not shown). The network coupled to network interface 160 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 160 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 160 and/or various components associated therewith may be implemented using hardware, software, or any combination thereof.

Network interface 160 may include wireless transceiver 162, which may provide wireless connectivity to various types of wireless networks, such as cellular telephony networks (e.g., 3G, 4G), wireless local area networks (e.g., IEEE 802.11), wireless personal area networks (e.g., Bluetooth®), single or dual band WiFi, and near field communication (NFC), among others. In operation, information handling system 100 may be enabled to send display data that is output on display screen 142 to a multi-device display unit via wireless transceiver 162.

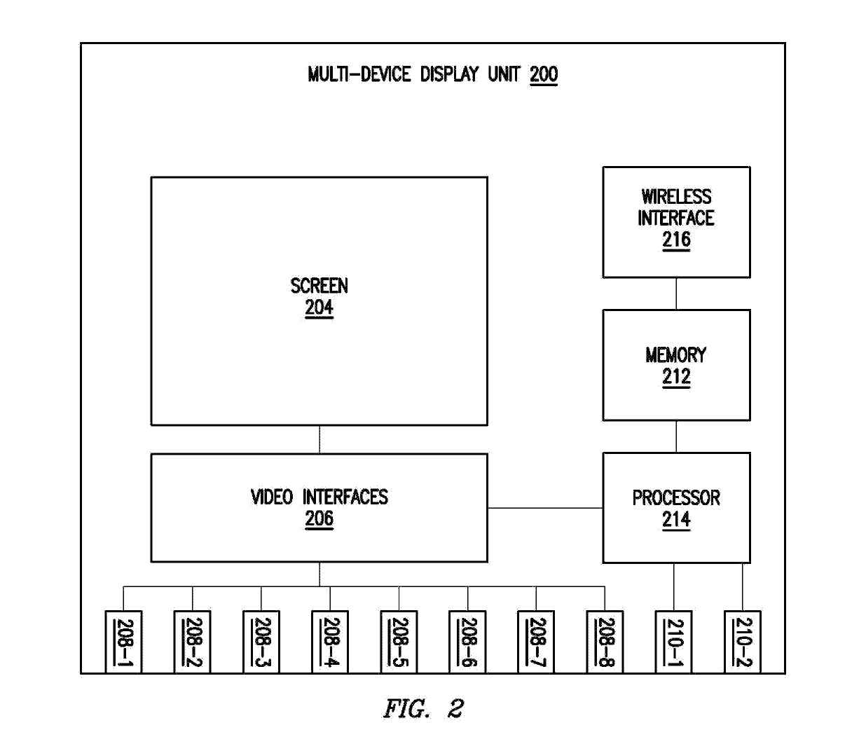

FIG. 2 illustrates a block diagram depicting selected elements of multi-device display unit 200 in accordance with some embodiments of the present disclosure. In some embodiments, multi-device display unit 200 may represent a stand-alone device that may be coupled to one or more information handling systems to output display data. In some embodiments, multi-device display unit 200 may include two or more separate housings or devices. For example, screen 204 may be in a housing separate from but communicatively coupled to other components of multi-device display unit 200. As used herein, the term “output” with regard to display data shall refer to display of optical elements (i.e., pixels) representing the display data on a screen and may represent a continuing process where the display data is constantly updated at a given refresh rate.

Multi-device display unit 200 accordingly includes screen 204, which may represent any of a variety of display screens and may be implemented in a fixed resolution corresponding to a number of pixels included within screen 204. In some embodiments, screen 204 may include an actively illuminated element, such as a backlight (not shown). Screen 204 may be implemented using various types of display technology, including, but not limited to, light-emitting diodes (LED), LCDs, plasma displays, or any other suitable display technologies. Screen 204 may generally include any system or apparatus operable to display one or more images corresponding to display data transmitted by one or more of external devices. For example, screen 204 may be operable to process display data and display images according to any image and/or video standard, protocol, format, and/or resolution, including without limitation video graphics array (VGA), super video graphics array (SVGA), extended graphics array (XGA), wide extended graphics array (WXGA), super extended graphics array (SXGA), super extended graphics array plus (SXGA+), wide super extended graphics array plus (WSXGA+), ultra extended graphics array (UXGA), wide ultra-extended graphics array (WUXGA), quad extended graphics array (QXGA), wide quad graphics extended array (WQXGA), 720p, 1080i, and 1080p. Further, although one screen 204 is depicted in FIG. 2, it is understood that multi-device display unit 200 may include any number of screens 204.

Video interfaces 206 are communicatively coupled to screen 204 and may include processing capability to receive display data and generate corresponding control signals to drive screen 204. Video interfaces 206 may be VGA interfaces, digital video interface (DVI), HDMI, MHL interface, any Video-In Video-Out (VIVO) interface, and/or any other suitable analog or digital interface. For example, video interfaces 206 may include one each of a VGA standard and an HDMI standard interface.

Multi-device display unit 200 includes one or more communication ports 208, for example communication ports 208-1 through 208-8. Communication ports 208 may represent wired interfaces for receiving display data from an information handling system (e.g., via communication ports 144 shown with reference to FIG. 1) and may be different types of ports or multiple instances of the same type of port. Communication ports 208 may include display interfaces that support one or more of the MHL standard, HDMI standard, or DP standard. Communication ports 208 may also include one or more USB ports (e.g., standard, mini or micro USB), one or more removable memory slots (e.g., SD card slots), and audio capabilities through the MHL, HDMI, or DP interfaces. Communication ports 208 may support bidirectional communication with an information handling system to both receive display data and to send/receive other information, such as display control information, including extended display identification data (EDID).

In multi-device display unit 200, processor 214 and memory 212 represent data processing functionality where memory 212 may store data and/or instructions executable by processor 214. Processor 214 may comprise a processing system and may also communicate with video interfaces 206, which may also include processing functionality (not shown). In some embodiments, processor 214 may be coupled to communication ports 208, either via video interfaces 206 as shown in FIG. 2 and/or directly.

Also shown in multi-device display unit 200 is wireless interface 216, which may represent a suitable wireless interface for receiving display data, for example, from wireless transceiver 162 of information handling system 100 as discussed with reference to FIG. 1. Although this disclosure describes and illustrates a particular wireless interface 216, this disclosure contemplates any suitable wireless interface.

I/O interfaces 210, e.g., I/O interfaces 210-1 and 210-2, may include hardware, software, or both, providing one or more interfaces for communication between multi-device display unit 200 and one or more I/O devices. One or more of these I/O devices may enable communication between a person and multi-device display unit 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 210 for them. Where appropriate, I/O interface 210 may include one or more device or software drivers enabling processor 214 to drive one or more of these I/O devices. Although this disclosure describes and illustrates a particular I/O interface 210, this disclosure contemplates any suitable I/O interface.

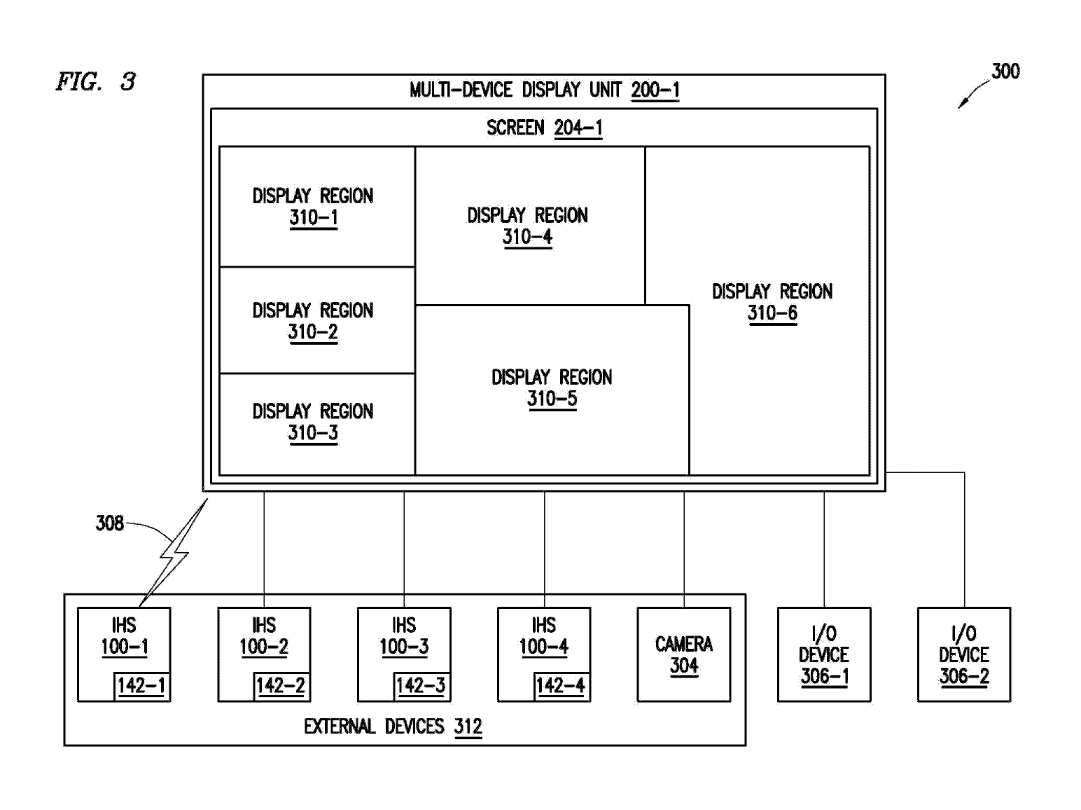

In operation, multi-device display unit 200 may be set up to receive display data from multiple information handling systems, such as information handling system 100 (see FIG. 1) via communication ports 208 and/or wireless interface 216. For example, when a personal mobile device of a user is communicatively coupled to communication port 208-1, for example, via a USB connection, multi-device display unit 200 may display the information from display screen 142 of the personal mobile device onto screen 204. When a second information handling system, e.g., a notebook computer, is communicatively coupled to communication port 208-2, multi-device display unit 200 may segment screen 204 into at least two display regions where one display region corresponds to the output from the personal mobile device, and a second display region corresponds to the output from the notebook computer. As another example, if the second information handling system is within operational proximity of wireless interface 216 and includes an activated wireless transceiver 162, multi-device display unit 200 may also segment screen 204 into at least two display regions where one display region corresponds to the output from the personal mobile device, and a second display region corresponds to the output from the second information handling system, e.g., the notebook computer with a wireless transceiver. The two display regions may thus concurrently and/or simultaneously output display data corresponding to both user devices, which may be desirable by the user. Further, the two display regions may be accessible and controlled by I/O devices communicatively coupled to I/O interfaces 210. In order to provide the user with certain display options for the display regions, multi-device display unit 200 may further communicate with the information handling systems to coordinate desired resolutions and screen orientations, as described in further detail with respect to FIG. 3.

FIG. 3 illustrates a block diagram depicting selected elements of multi-device display system 300 in accordance with some embodiments of the present disclosure. As shown, multi-device display system 300 includes multi-device display unit 200-1, external devices 312 including information handling systems 100-1 through 100-4 and camera 304, and I/O devices 306-1 and 306-2. Multi-device display unit 200-1 may represent an embodiment of multi-device display unit 200 (see FIG. 2). Although multi-device display system 300 is depicted as having four information handling systems 100 and one camera 304 for a total of five external devices 312, it will be understood that, in particular embodiments, different numbers and types of external devices 312 may be communicatively coupled to multi-device display unit 200-1 at any given time. Information handling systems 100-1 through 100-4 may represent embodiments of information handling system 100 (see FIG. 1). For example, information handling system 100-1 may be a mobile phone, information handling system 100-2 may be a tablet computer, information handling system 100-3 may be a notebook computer, and information handling system 100-4 may be a desktop computer. Wireless link 308 may represent a direct wireless interface between information handling system 100-1 and multi-device display unit 200-1, as described previously.

In operation of multi-device display system 300, multi-device display unit 200-1 may be communicatively coupled to information handling system 100-1 to output a single display region 310-1 that approximately replicates display screen 142-1 of information handling system 100-1. When information handling system 100-2 is communicatively coupled to multi-device display unit 200-1, then multi-device display unit 200-1 may reconfigure screen 204-1 to simultaneously output display region 310-1 and display region 310-2. Display region 310-1 may correspond to display data received from information handling system 100-1, e.g., display screen 142-1, while display region 310-2 may correspond to display data received from information handling system 100-2, e.g., display screen 142-2.

As further example, when information handling system 100-3 and/or 100-4 are communicatively coupled to multi-device display unit 200-1, then multi-device display unit 200-1 may reconfigure screen 204-1 to simultaneously output display regions 310-1, 310-2, 310-3, and/or 310-4. Display region 310-3 may correspond to display data received from information handling system 100-3, e.g., display screen 142-3, and display region 310-4 may correspond to display data received from information handling system 100-4, e.g., display screen 142-4.

In some embodiments, external devices 312 may include one or more cameras 304. Camera 304, for example a closed-captioned television (CCTV) camera, may not include an external display. When camera 304 is communicatively coupled to multi-device display unit 200-1, then multi-device display unit 200-1 may reconfigure screen 204-1 to simultaneously output five display regions 310-1, 310-2, 310-3, 310-4, and 310-5. Display region 310-5 may correspond to display data received from camera 304. Accordingly, multi-device display unit 200-1 may be configured to provide for display, access, and control of multiple external devices 312 approximately simultaneously.

It is noted that display regions 310 are shown in FIG. 3 with arbitrary size and orientation for descriptive generality. In various embodiments, the arrangement of display regions 310 may be different than shown in FIG. 3, and may depend upon overall display properties of multi-device display unit 200-1. For example, display region 310-1 may be output on an entire left half of multi-device display unit 200-1. In some embodiments, multi-device display unit 200-1 may itself be in portrait mode, such that display region 310 are arranged vertically adjacent to one another.

In some embodiments, display regions 310 may be adjusted, modified, or otherwise configured based on user preferences. As such, the replication of display screens 142 onto regions 310 may alter the original size of display screens 142, e.g., the replication onto a specific display region 310 may increase or decrease the size of the display on display screens 142. For example, a mobile phone display, e.g., display screen 142-1, may be displayed larger in display region 310-1 of screen 204 than the same image is displayed on display screen 142-1.

A user of multi-device display unit 200-1 may view, access, and/or control each of external devices 312 via the corresponding display region 310 of screen 204. For example, accessing an application visible on display region 310-1 may access the application on information handling system 100-1. Accordingly, a user of a mobile phone may be able to use screen 204 to get a larger display of the mobile phone screen and browse the mobile applications through mouse, keyboard, and/or touch screen associated with multi-device display unit 200-1. Further, if more than one information handling system 100 is connected to multi-device display unit 200-1, a user may flexibly browse all external devices 312 in parallel using I/O devices 306, e.g., mouse and/or keyboard, and a touchscreen if screen 204 is so enabled.

In some embodiments, camera 304 may not include a display. In this case, a user may use I/O devices 306 connected to multi-device display unit 200-1 to manipulate the output from camera 304. For example, I/O device 306-1 may be able to zoom-in, zoom-out, or otherwise manipulate the output from camera 304. In such a configuration, camera 304 may be monitored while other external devices 312 may be utilized by a user of multi-device display unit 200-1.

Fewer external devices 312 communicatively coupled to multi-device display unit 200-1 may result in fewer display regions 310. As an example, two information handling systems 2100 may be communicatively coupled to multi-device display unit 200-1. In this case, each display screen 142 may be replicated on one-half of screen 204. If the two external devices are a mobile phone and a laptop computer operated by different users, users of each external device may have a larger view of their individual display screens 142. In addition to having a larger screen than a mobile phone display, a user of the mobile phone may improve browsing of the mobile phone applications by using a mouse, keyboard, or touch screen, if screen 204 is so enabled. Since the second external device, the laptop computer, has its own built-in keyboard and mouse, the user of the laptop computer may simultaneously browse and access the laptop's applications viewed on screen 204.

In some embodiments, multi-device display unit 200-1 may detect the addition or removal of a particular external device 312 to a particular communications port 208. Multi-device display unit 200-1 may dynamically increase, decrease, or otherwise adjust the size of any of display regions 310 based on the addition or removal of external devices 312. In some embodiments, multi-device display unit 200-1 may provide a user an interface to specify automatic dynamic adjustment or manually adjust the size or position of any of display regions 310.

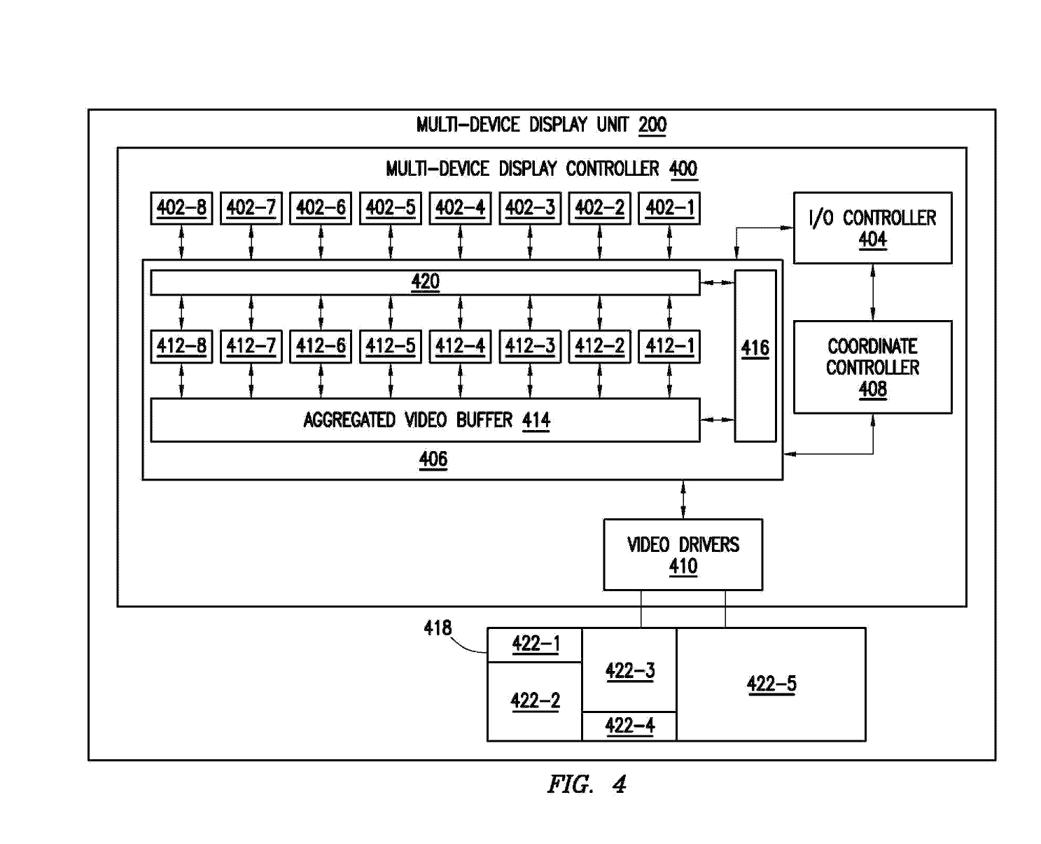

FIG. 4 illustrates a functional diagram depicting selected elements of multi-device display unit 200 in accordance with some embodiments of the present disclosure. Multi-device display controller 400 may include device controllers 402, I/O controller 404, partition controller 406, coordinate controller 408, video drivers 410, and/or any other suitable modules or controllers.

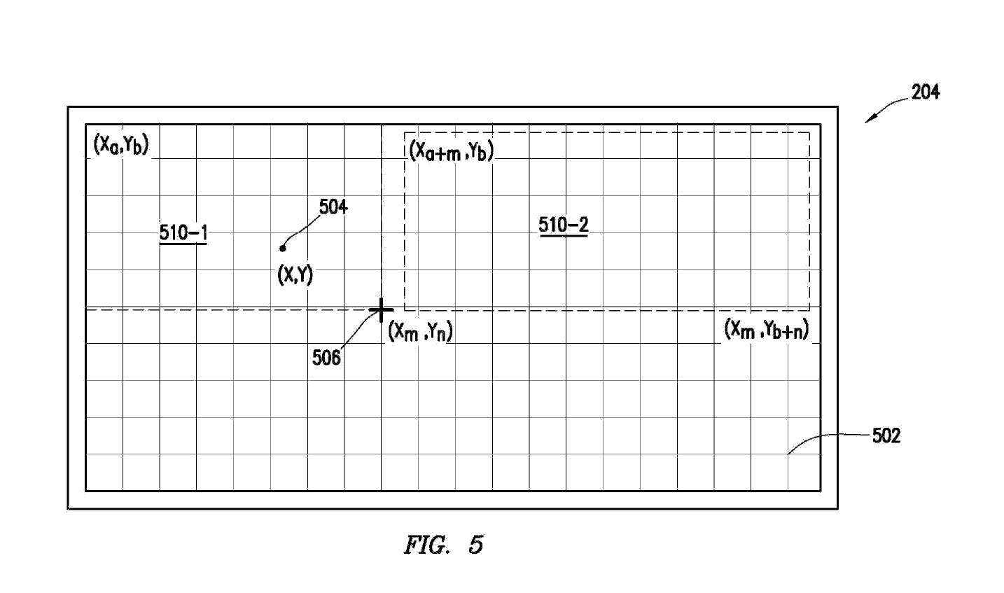

I/O controller 404 includes hardware, software, or both, providing one or more interfaces for communication between multi-device display unit 200 and one or more I/O devices. I/O controller 404 may include a processor, controller, memory or any other suitable components. I/O devices, such as a keyboard and mouse, may be connected or coupled to I/O controller 206. Detection of an I/O device connection by I/O controller may initiate a sizing operation on screen 204 as discussed with reference to FIG. 5 below.

Device controllers 402, e.g., device controllers 402-1 through 402-8, include hardware, software, or both, providing one or more interfaces for communication between multi-device display unit 200 and one or more information handling systems 100 or other external devices 312. Device controllers 402 may be configured to detect connection of different external devices 312 to multi-device display unit 200, and communicate to partition controller 406 information regarding the connected external device 312. During operation, the video out of external devices 312 may be input into a respective device controller 402. For example, the video out of an information handling system 100-1, such as a mobile phone, may be input into device controller 402-1. Device controllers 402 may transmit or otherwise communicate the video frames received from external devices 312 to partition controller 406.

Partition controller 406 includes hardware, software, or both, to partition screen 204 into multiple display regions 310. Partition controller 406 may include three subsystems: video buffers 412, aggregated video buffer 414, and interpreter 416. Video buffers 412 may be utilized for receiving the video output of different external devices 312 from respective device controllers 402, and streamlining the video of respective device controllers 402. The video frames may be read from video buffers 412 and scaled into aggregated video buffer 416 at a particular partition {(Xₐ, Y_{b}), (Xₘ, Yₙ)} video matrix to create display regions 310, which will be projected onto screen 204. Aggregated video buffer 416 places the individual video frame streams into a corresponding partitioned area to generate a single video frame. The single video frame is transmitted from partition controller 406 to screen controller 418.

Interpreter 416 includes hardware, software, or both that reads the (X, Y) video matrix coordinates from an I/O device, e.g., mouse, keyboard, or touch screen, and maps the read coordinates against the video buffer matrix to determine each display region 310, as discussed with reference to FIG. 3. For example, interpreter 416 may map the coordinates selected via dragging a mouse (described below with reference to FIG. 5) onto the matrix of aggregated video buffer 414. Each matrix is mapped to a respective video buffer 412, which in turn maps to a respective device controller 402. Interpreter 416 may cache the matrix of individual display regions 310 for each video buffer 412. Aggregated video buffer 414 includes hardware, software, or both that may include a central buffer that includes signals, commands, and video data from each connected external device 312.

Resolution controller engine 420 includes hardware, software, or both that scales the resolution between any coupled external devices 312 (discussed with reference to FIG. 3) with selected display regions 310 of screen 204. Resolution controller engine 420 scales a pixel buffer associated with one or more device controllers 402 into aggregated video buffer 414 by converting an input pixel ratio from one or more device controllers 402 to an output pixel ratio of aggregated video buffer 414. For example, information handling system 100-2, which may be a smart phone, may be coupled to the multi-device display controller 400 at device controller 402-2, and may have an input device resolution of approximately 400×640. Resolution controller engine 420 may scale the input device resolution to correspond to the display aspect ratio of the selected or designated display region 310, in the present example, display region 310-2. For example, display region 310-2 may have a display aspect ratio of approximately 760×1280. Resolution controller engine 420 may scale each of the input device resolutions, e.g., approximately 400×640, to correspond to each of the display aspect ratios, e.g., approximately 760×1280. Resolution controller engine 420 may further communicate with interpreter 416 as a component of scaling resolutions between device controllers 402 and aggregated video buffer 414.

In operation, device controllers 402 transmit pixel data to the resolution controller engine 420 and the mapped video buffers 412. Video buffers 412 streamline the pixel data. Partition controller 406 scales the video buffer resolution and creates a video buffer matrix in aggregated video buffer 414. The video matrix is calibrated with a buffer associated with screen controller 418.

Screen controller 418 includes hardware, software, or both that may be configured to display each individual matrix 422 on screen 204 simultaneously in corresponding display regions 310. For example, individual matrix 422-1 may correspond to a portion of aggregated video buffer 414 that is associated with the display from a particular external device 312 coupled to device controller 402-1. Individual matrix 422-2 may correspond to a portion of aggregated video buffer 414 that is associated with the display from a particular external device 312 coupled to device controller 402-2. Individual matrix 422-3 may correspond to a portion of aggregated video buffer 414 that is associated with the display from a particular external device 312 coupled to device controller 402-3. Individual matrix 422-4 may correspond to a portion of aggregated video buffer 414 that is associated with the display from a particular external device 312 coupled to device controller 402-4. Screen controller 418 may also be configured to determine if portions of screen 204 are not mapped to any device by partition controller 406. Portions of screen 204 that are not mapped may be deactivated (turned-off) by screen controller 418. For example, individual matrix 422-5 may correspond to a portion of aggregated video buffer 414 that is not associated with any external device 312.

In some embodiments, multi-device display controller 400 includes coordinate controller 408. Coordinate controller 408 may be communicatively coupled to I/O controller 404 and may be configured to receive data related to movements of an I/O device, e.g., mouse, keyboard, or touchscreen. Coordinate controller 408 may be integrated with aggregated video buffer 414. In operation, a mouse movement on screen 204 may be transmitted to coordinate controller 408. Coordinate controller 408 may transmit the coordinates of the movement to aggregated video buffer 414. Aggregated video buffer 414 may map the coordinates to the appropriate video buffer 412 and the video buffer 412 may transmit the movement to the appropriate device controller 402. The appropriate device controller 402 may transmit the change to the appropriate external device 312.

In some embodiments, multi-device display controller 400 may be communicatively coupled to and integrated into a housing of screen 204. If multi-device display controller 400 is not integrated with screen 204, then there may be an external connection between multi-device display controller 400 and screen 204. Multi-device display controller 400 may be in a separate housing from screen 204 and may be connected via video ports or other suitable communicatively coupling mechanism. If multi-device display controller 400 is separate from screen 204, multi-device display controller 400 may be used in conjunction with any suitable existing monitor or screen and may be referred to as a “smart display adapter

In some embodiments, multi-device display unit 200 may provide appropriate hardware and software to connect one or more external devices 312 to one or more screens 204. Using multi-device display unit 200 may reduce or eliminate the need for a separate information handling system (e.g., a laptop or desktop personal computer) with proprietary software to connect external devices 312 with screen 204 to display and/or access each of the external devices 312 simultaneously. Multi-device display unit 200 may be capable to include substantially the same display data from each of external devices 312 with no or minimal alteration. Multi-device display unit 200 may also be capable to allow a user of multi-device display unit 200 to access and control each of external devices 312. When external devices 104 are connected to multi-device display unit 200, external devices 312 may be accessed and controlled by I/O devices associated with each of the external devices 312 or associated with multi-device display unit 200. For example, two external devices 312, such as two laptop computers, may be connected to multi-device display unit 200. Display screen 142 from each laptop may appear on screen 204 of multi-device display unit 200, e.g., one on each half of screen 204. Further, two different users may be accessing or controlling each laptop either at each laptop or at the I/O devices connected to multi-device display unit 200.

FIG. 5 illustrates an exemplary screen 204 for generating display regions 510 in accordance with some embodiments of the present disclosure. Display regions 510 may be apportioned using I/O devices, e.g., a mouse or a touchscreen. At power on of screen 204 communicatively coupled to multi-device display controller 400, grids 502 may be produced on screen 204. Grids 512 may include horizontal and/or vertical guidelines to assist a user in selecting a respective display region 510 for a respective external device 312. Grids 502 may be of any suitable size. For example, if screen 204 has an approximately 21 inch diagonal size, grids may be approximately 1.78×1.11 inches. In some embodiments, multi-device display controller 400 may automatically apportion screen 204 each time a particular external device 312 is connected or removed from a communication port, such as communication ports 208 discussed with reference to FIG. 2. In some embodiments, an I/O device, e.g., a mouse, may be utilized to select, e.g., by clicking and dragging, a portion of screen 204 to select a display region, e.g., display region 510-1 associated with a particular external device. For example, on the application of power to screen 204, sizing plus 506 may be generated on screen 204. A user may employ a mouse to select sizing plus 506 and drag sizing plus 506 from (Xₐ, Y_{b}) to (Xₘ, Yₙ). Accordingly, display region 510-1 may form a quadrilateral that extends from corner (Xₐ, Y_{b}) to corner (Xₘ, Yₙ). Display regions 510 may be formed and resized by using sizing plus 506. Sizing plus 506 and a corresponding ability to configure or reconfigure display regions 510 may be activated by a specialized I/O signal, e.g., clicking left and right buttons of a mouse three times or tapping a touch screen three times. Such a specialized signal may activate and make visible on screen 204 one or both of sizing plus 506 and grids 502. As another example, a second external device 312 may be connected and a mouse may be utilized to select display region 510-2 associated with the second external device 312. Display region 510-2 may form a quadrilateral that extends from corner (Xₐ₊ₘ, Y_{b}) to corner (Xₘ, Y_{b+n}). Display regions 510 may thus be of any desired size and may be resized as needed. Accordingly, the selected display regions 510 form a portion for replicating display screens 142 of the connected external devices 312. Further, location of a particular display region 510 corresponding to a particular external device 312 may be determined by locator 504, which may be based on a mouse click or touch coordinate.

In some embodiments, screen 204 may be configured such that individual grids 502 may be powered on off. Grids 502 not selected by multi-device display controller 400 or a user may automatically or manually turn-off or dim and thus, improve power savings or efficiency. Further, in the portion of screen 204 that is selected to create display regions 510, grids 502 may no longer be visible.

In some embodiments, the size and/or location of display regions 510 may be modified by a variety of methods. For example, an action, such as clicking a mouse left and right button three times, may activate grids 502 to reappear so that the display regions 510 may be dynamically shrunk or expanded. As another example, screen 204 that is touchscreen enabled may activate grids 502 with three taps of the screen.

In some embodiments, selection of a particular external device 312 to interact with may be allowed by selecting the device through a mouse click, screen tap, tab entry, or any other suitable selection mechanism. Once selected, the particular external device may be accessed, modified, navigated, or any other suitable activity.

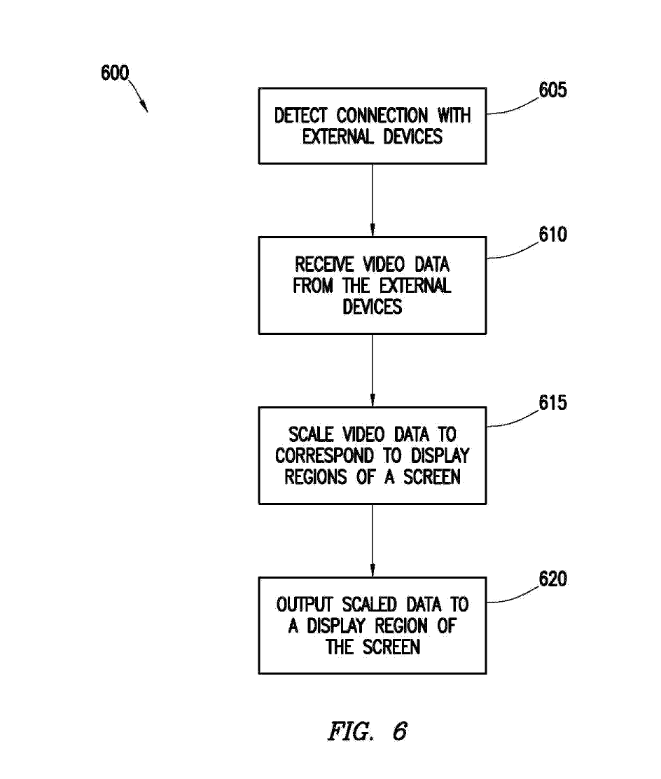

FIG. 6 illustrates a flowchart of an example method for utilizing a multi-device display unit in accordance with some embodiments of the present disclosure. The steps of method 600 may be performed by various computer programs, models or any combination thereof. The programs and models may include instructions stored on a non-transitory computer-readable medium that are operable to perform, when executed, one or more of the steps described below. The computer-readable medium may include any system, apparatus or device configured to store and/or retrieve programs or instructions such as a microprocessor, a memory, a disk controller, a compact disc, flash memory or any other suitable device. The programs and models may be configured to direct a processor or other suitable unit to retrieve and/or execute the instructions from the computer-readable medium. For example, method 600 may be executed by a processing system of a multi-device display unit and/or other suitable source. For illustrative purposes, method 600 may be described with respect to the multi-device display unit 200 of FIG. 2; however, method 600 may be used for multi-device display of any suitable configuration.

At step 605, the processing system detects a connection with one or more external devices. For example, with reference to FIG. 3, processing system may detect the presence of information handling system 100-1 and information handling system 100-2. The processing system may detect the presence of the external devices through connection with communication ports, such as communication ports 208 shown in FIG. 3. The connection may be a USB connection or a wireless connection.

At step 610, the processing system receives video data from the one or more external devices. For example, as discussed with reference to FIG. 5, each of the external devices may transmit video data to device controllers 402, which may transmit the data to a partition controller. The video data may be associated with a display screen at an information handling system or may be from a device without a display screen, such as a camera.

At step 615, the processing system scales the video data to correspond to regions of a screen. For example, resolution controller engine 420 may scale each of the display resolutions from external devices 312 that correspond to device controllers 402. Further, aggregate video buffer 414 may scale each of the inputs from video buffers 412 to fit in specified or selected partitions of screen 204. The scaled data may be output as individual matrices 422 and/or a video frame to screen controller 418 for display on screen 204.

At step 620, the processing system outputs the scaled video data to a display region of the screen. For example, the scaled video data from a first external device may be output to a selected or defined display region 310 of screen 204. The size of display regions 310 may be defined and/or modified by the processing system or a user via an I/O device. Method 600 may be repeated as additional external devices are connected to the multi-device display unit.

As described herein, a multi-device display unit may, responsive to a user-selection or automatically, divide a screen into different display regions corresponding to video data received from different user devices, such as a tablet and a notebook computer.

Modifications, additions, or omissions may be made to method 600 without departing from the scope of the present disclosure and invention. For example, the order of the steps may be performed in a different manner than that described and some steps may be performed at the same time. For example, step 610 and step 620 may be performed simultaneously. Additionally, each individual step may include additional steps without departing from the scope of the present disclosure. For example, step 615 may include additional steps or options as described herein without departing from the scope of the present disclosure.

Although the present invention and its advantages have been described in detail, it should be understood that various changes, substitutions and alternations can be made herein without departing from the spirit and scope of the invention which is solely defined by the following claims.

What is claimed is:

1. A method for a multi-device display comprising:
detecting, at a multi-device display controller, a first connection with a first external device and a second connection with a second external device;
receiving video data from the first external device and the second external device;
scaling the video data from the first external device to correspond to a first region of a screen, the screen associated with the multi-device display controller;
scaling the video data from the second external device to correspond to a second region of the screen; and
outputting the scaled video data from the first external device to the first region of the screen and the scaled video data from the second external device to the second region of the screen.

2. The method of claim 1, further comprising determining a size of the first region based on receiving a signal.

3. The method of claim 2, further comprising determining an adjusted size of the first region based on receiving a second signal.

4. The method of claim 1, further comprising automatically determining the size of the first region based on a type of the first external device.

5. The method of claim 1, wherein the screen is integrated with the multi-device display controller.

6. The method of claim 1, wherein the first external device comprises an information handling system, and wherein the second external device comprises a camera.

7. The method of claim 1, wherein the video data from the first external device corresponds to a display screen of the first external device.

8. A multi-device display unit comprising:
a screen; and
a multi-device display controller communicatively coupled to the screen, the multi-device display controller having a processor with access to a memory, wherein the memory stores instructions that, when executed by the processor, cause the processor to:
detect a first connection with a first external device and a second connection with a second external device;
receive video data from the first external device and the second external device;
scale the video data from the first external device to correspond to a first region of the screen;
scale the video data from the second external device to correspond to a second region of the screen; and
output the scaled video data from the first external device to the first region of the screen and the scaled video data from the second external device to the second region of the screen.

9. The multi-device display unit of claim 8, wherein the processor is further caused to determine a size of the first region based on receiving a signal.

10. The multi-device display unit of claim 9, wherein the processor is further caused to determine an adjusted size of the first region based on receiving a second signal.

11. The multi-device display unit of claim 8, wherein the processor is further caused to automatically determine the size of the first region based on a type of the first external device.

12. The multi-device display unit of claim 8, wherein the screen is integrated with the multi-device display controller.

13. The multi-device display unit of claim 8, wherein the first external device comprises an information handling system, and wherein the second external device comprises a camera.

14. The multi-device display unit of claim 8, wherein the video data from the first external device corresponds to a display screen of the first external device.

15. A non-transitory computer-readable medium storing instructions, that, when executed by a processor of a multi-device display unit, cause the processor to:
detect a first connection with a first external device and a second connection with a second external device;
receive video data from the first external device and the second external device;
scale the video data from the first external device to correspond to a first region of a screen, the screen associated with the multi-device display unit;
scale the video data from the second external device to correspond to a second region of the screen; and
output the scaled video data from the first external device to the first region of the screen and the scaled video data from the second external device to the second region of the screen.

16. The non-transitory computer-readable medium of claim 15, wherein the processor is further caused to determine a size of the first region based on receiving a signal.

17. The non-transitory computer-readable medium of claim 16, wherein the processor is further caused to determine an adjusted size of the first region based on receiving a second signal.

18. The non-transitory computer-readable medium of claim 15, wherein the processor is further caused to automatically determine the size of the first region based on a type of the first external device.

19. The non-transitory computer-readable medium of claim 15, wherein the screen is integrated with the multi-device display unit.

20. The non-transitory computer-readable medium of claim 15, wherein the first external device comprises an information handling system, and wherein the second external device comprises a camera.
